(19) United States
(12) Patent Application Publication
(10) Pub. No.: US 2008/0028031 A1
(43) Pub. Date: Jan. 31, 2008

(54) METHOD AND APPARATUS FOR MANAGING INSTANT MESSAGING

(76) Inventors: Byron Lewis Bailey, Savage, MN (US); Richard Dean Dettinger, Rochester, MN (US); Zachary Adam Garbow, Rochester, MN (US); Gregory Richard Hintermeister, Rochester, MN (US); Robert Douglas Holt, Rochester, MN (US); Jason Allan Nikolai, Rochester, MN (US); Kevin Glynn Paterson, San Antonio, TX (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/459,694

(22) Filed: Jul. 25, 2006

(51) Int. Cl. G06F 15/16

(52) U.S. Cl. 709/207; 709/206

(57) ABSTRACT

An instant messaging system having logic for managing IM messages and an intelligent queuing mechanism. One aspect of the present invention is a method for selectively filtering instant messages, comprising receiving an instant message and analyzing the instant message to generate a priority score. Another aspect of the present invention is a graphical user interface for an instant messaging application, comprising at least one visible conversation pane for displaying relatively higher priority conversations, and at least one minimized conversation pane representing relatively lower priority conversations to the at least one minimized conversation panel.

### CROSS-REFERENCE TO RELATED APPLICATION

This application is related to the following commonly owned application: U.S. patent application Ser. No. ______, filed on ______, 2006, entitled “MONITORING AND RESPONDING TO INSTANT MESSAGING USER ACTIVITY”, Attorney Docket No. ROC920060009US1.

### FIELD OF THE INVENTION

The present invention relates to digital communication systems, and in particular, to systems for managing the flow of instant messages over a computer network.

### BACKGROUND

The latter half of the twentieth century has been witness to a phenomenon known as the information revolution. While the information revolution is a historical development broader in scope than any one event or machine, no single device has come to represent the information revolution more than the digital computer. Each year, computer systems grow faster, store more data, and provide more applications to their users. Thus, information that was too expensive to gather, store and process a few years ago, is now economically feasible to collect and manipulate via computer. These reduced costs, in turn, have driven tremendous increases in worker productivity, as product designs, manufacturing processes, resource scheduling, administrative chores, and many other factors, are made more efficient.

Today, most computer systems used in commercial business environments are now connected to each other by some type of network, such as the Internet, that allow employees to communicate with each other electronically. In many environments, this is an essential part of these workers' respective jobs. This trend is a logical consequence of the information revolution; information is most useful when shared.

Instant messaging is a type of computer application designed to facilitate communication among multiple computer users attached to a network. Instant messaging may be implemented in various ways, but in general it supports the sending and receiving of messages that appear on the computer display of the recipient more or less in real-time after being sent, as opposed to the more traditional e-mail messages, which typically are logged until the recipient wishes to view them. This characteristic gives instant messaging a spontaneous, conversational quality, and thus helps to provide an alternative form of communication using computers attached to a network. Such communication may be used by a variety of users, from groups of individuals working closely together on some critical project, to more casual users at home who simply want to see who is available to receive a message immediately.

Real-time textual conversations, commonly known as “chats,” have become popular among both personal and business computer users. Chats frequently occur as conversations between two people; as conferences among larger groups; and in persistent chat rooms or spaces accessible to a larger community who can drop in, read what was recently written, and contribute if they desire. The textual nature of instant messaging makes it particularly valuable in some settings. For example, chats can be conducted while people are on the phone, allowing it to be used as a second channel for exchanging information. Similarly, because of the persistent nature of text, a user can catch up on anything that was said in a chat if they were momentarily distracted or interrupted. Instant messages can also be an inexpensive and lightweight way for people to exchange information in real time. These and other reasons contribute to the growing use of chat in business settings and the increasing incorporation of instant messaging into the offerings of major software manufacturers.

Conventional instant messaging systems are not without their drawbacks, however. For example, when multiple conversations are going on at once, it can be very difficult to manage the conversations. Instant messaging can also be a distraction when someone is working on something important and that person does not want to be disturbed. For example, an employee in the development phase of a mission-critical project may not want any distractions from their instant messaging chat clients except for the one or two co-workers with whom they are working. Using conventional chat clients, the employee will need to manually set their chat client to reject all chat requests from everyone except the co-workers, then need to remove this restriction to allow others to initiate chats when they again become available to chat. This capability is restrictive and is not flexible.

These drawbacks often lead users to “hide” from their friends and coworkers by logging out of their instant messaging system or changing their status to “away”. This suggests that widespread, simultaneous instant messaging may actually decrease in effectiveness as the number of users increases—a remarkable contrast to the typical Internet effect.

Accordingly, there needs to be a way to assign priorities to particular conversations, users, and topics, so that the primary user can handle the most important conversations first. In addition, there needs to be a way to filter the excess noise that is associated with modern instant messaging usage. Prioritization based on the person or content and the reduction of excess noise/distractions is the focus of this disclosure.

### SUMMARY

The present invention provides an instant messaging system having logic for managing IM messages and an intelligent queuing mechanism. These enhancements filter and reduce excess noise and distractions within an instant messaging environment, such as prioritizing based on the person or content. This prioritization may include an analysis of activity at the recipient's workstation, the sender's workstation, or a combination of both.

Accordingly, one aspect of the present invention is a method for selectively filtering instant messages, comprising receiving an instant message and analyzing the instant message to generate a priority score. In some embodiments, the analyzing comprises generating a default priority score for the instant message based at least in part on the identify of a sender of the instant message and a group associated with a sender of the instant message, then dynamically updating that score. The dynamic component may be calculated detecting user activity on a client device; and changing the priority score based on the analysis.

Another aspect of the present invention is a graphical user interface for an instant messaging application, comprising at least one visible conversation pane for displaying relatively higher priority conversations, and at least one minimized conversation pane representing relatively lower priority conversations to the at least one minimized conversation panel. Some embodiments may also have a busy-ness level selector for indicating a priority score required to have a message displayed in the at least one visible conversation pane.

### BRIEF DESCRIPTION OF THE DRAWINGS

FIG. 1 illustrates one embodiment of an instant messaging system.

FIG. 2 illustrates a database schema suitable for use with the instant messaging system of FIG. 1.

FIG. 3 depicts an instant messaging graphical user interface.

FIG. 4 illustrates a data structure embodiment used to classify individuals.

FIG. 5 illustrates one method of managing a priority queue.

FIG. 6 illustrates one method of determining an activity level.

FIG. 7 illustrates the operation of the sending IM client.

FIG. 8 illustrates the operation of the receiving IM client.

FIG. 9 illustrates one method of calculating a priority score using metadata.

FIG. 10 illustrates a computer system suitable for use as a client device or an IM server system.

FIG. 11 illustrates a method of managing online presence.

### DETAILED DESCRIPTION

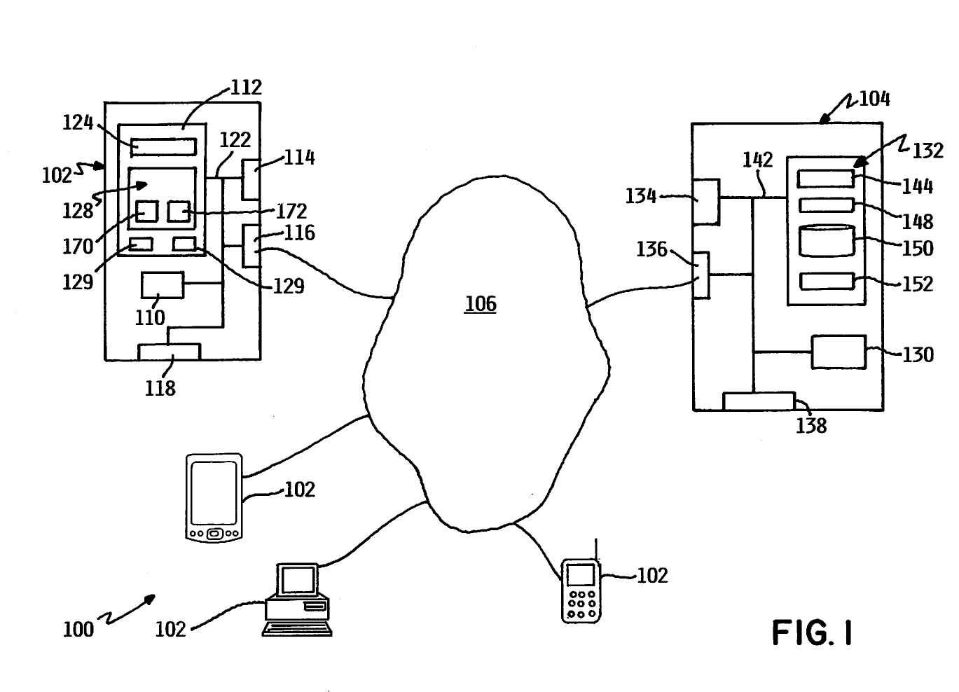

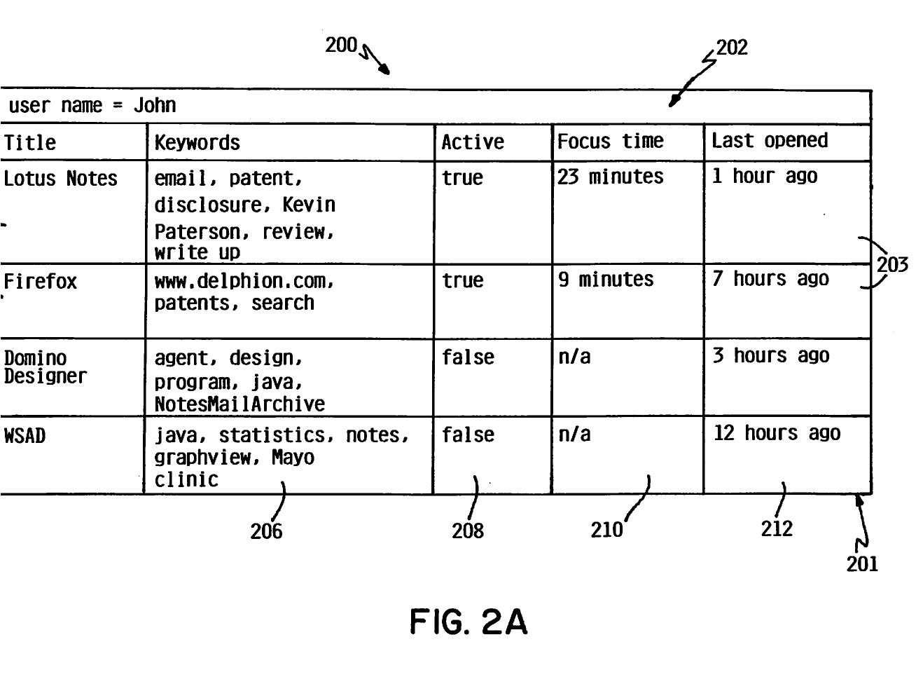

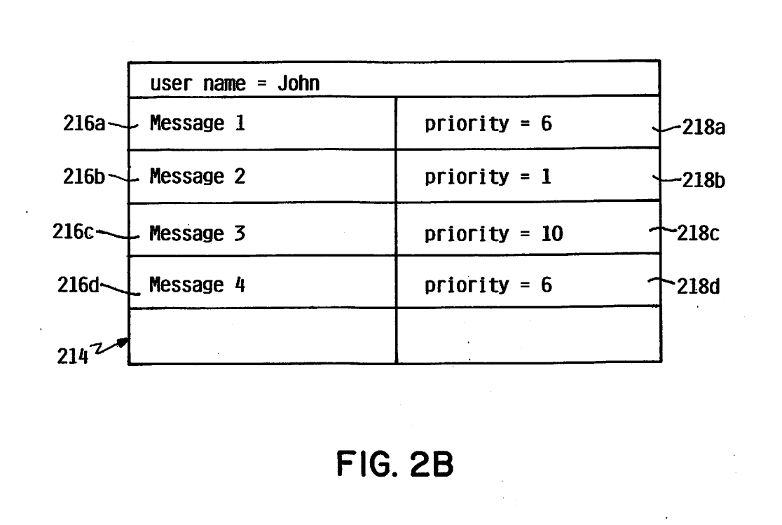

FIGS. 1-2 illustrate one embodiment of an instant messaging (“IM”) system 100. As best shown in FIG. 1, this IM system 100 comprises a plurality of client devices 102 (for clarity, only one shown in detail) connected to an IM server computer 104 by a communications medium 106. Each of the client devices 102 comprises a central processing unit 110 connected to a main memory 112, a mass storage interface 114, a network interface 116, and an input/output (“I/O”) interface 118 by a system bus 122. The memory 112 in each client device 102 comprises an operating system 124 and an instant messaging (“IM”) client application 128. The instant messaging client 128, in turn, comprises a client GUI 170 and an activity-monitoring program 172. Each client GUI 170 is designed to allow its primary user (e.g., the individual sitting at the computer screen) to send instant messages to other users of the IM system.

The IM server computer 104 in this embodiment similarly includes a central processing unit 130 connected to a main memory 132, a mass storage interface 134, a network interface 136, and an I/O interface 138 by a system bus 142. The memory 132 in the server computer 103 contains an operating system 144, an instant messaging backend program 148, a database program 150, and a message queuing manager 152. As best shown in FIGS. 2A-2B, the database program 150 provides access to a database 200 comprising a plurality of user records 201. Each user record 201 contains a user name field 202, metadata field(s) 203, and a message queue 214. The metadata field 203, in turn, comprises a list of applications 204, a list of keywords associated with that application 206, an active indicator 208, a focus time field 210, a last opened field 212, and a message queue 214. The message queue 214 comprises a list of received messages 216a-216d and their corresponding priority values 218a-218d.

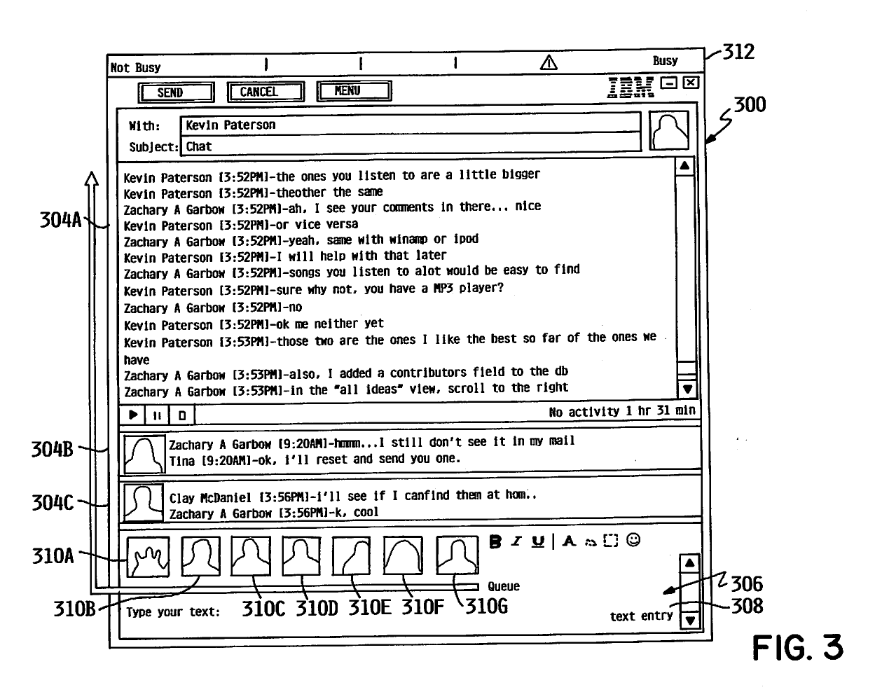

FIG. 3 illustrates a chat interface window 300 generated by the client GUI 170. This interface window 300 comprises a user-selectable number of conversation sub-panes 304a-304c (as depicted in FIG. 3) and an input pane 306. Each sub-pane 304 contains a chat history for one conversation. Sub-pane 304a contains a chat history of the highest priority chat session; sub-pane 304b contains a chat history of the next highest priority chat session, etc. The input pane 306 comprises a text entry zone 308 in which users can input the message they wish to add to one of the conversations, a plurality of minimized conversation selector icons 310a-310n that allow users to select which conversation the inputted message will be sent, and a busyness slider 312 that allows users to adjust the priority score required to have a message displayed on the screen. The selection icons 310a-310c in this embodiment are associated with the highest priority chats (displayed in sub-panes 304a-304c, respectively), and minimized conversation selection icons 310d-310g represent other lower priority chats that reside in a priority queue 214 (described in more detail with reference to 2B) but are not displayed in one of the visible sub-panes 304.

In operation, the IM system 100 assigns a default priority level to each other user of the IM system 100, then dynamically adjusts that priority level accordance with the users' (i.e., both the user of the primary client device 102 and the other client devices 102 in the system) activities. Using this information, the IM system 100 can determine an “on-line presence level” that affects the ability of other messaging users to see whether the primary user is on-line. That is, the on-line presence level in this embodiment is a score that dynamically limits the visibility of the primary user of a device 102 to specific other users. Thus, for example, if the chat client user (called client A) has configured priorities for users listed in their chat client and the presence level threshold is “priority 3,” users of other chat clients 102 will only be notified that Client A is on-line if their associated priority is “3” or higher. Similarly, the IM system 100 uses these priority levels to determine whether or not to display immediately messages between pairs of users. That is, messages from high priority users are immediately displayed visible panes 304a-304c, whereas messages from low priority users are assigned to minimized panes 304d-304g.

In this embodiment, the priority score comprises a base score plus a dynamic modifier. The base levels can be set when the primary user adds a person to their “buddy” list and can be modified freely thereafter. Base priority scores also can be associated with groups. In these embodiments, each member of the group will automatically gain the group's base priority score if the base priority of the group is higher than the user's own base priority score.

The IM system 100 generates the dynamic component by analyzing the activities of its primary user, the interactive patterns of the primary user, and the activities of other participants in the chat sessions to determine priority levels associated with each conversation. That is, each chat session has a priority score that is increased or decreased according to one or more of the following criteria: (i) with respect to a particular chat partner, the overall importance assigned to their chat partner, a frequency of general interaction with that chat partner, a average response time for the user to respond to messages from that chat partner, and a length of time it takes that chat partner to respond to the user's messages, and whether the user is actually waiting for a response as opposed to working on something else; (ii) with respect to all users of the messaging system 100, a length of time a particular user has been waiting for response, an amount of text received without a response, a text entry pane containing text not-yet-sent, and whether or not one of the participants in a chat will be leaving shortly; and (iii) with respect to the overall environment, an online status indicator of the chat partners (e.g., priority decreases when the partner goes off-line, to do-not-disturb, etc.) The system 100 will then dynamically adjust who can see the primary user online and dynamically rearranges the chat icons 310 as their priority level within the queue changes. In this way, the highest priority session is displayed in the largest chat window 304A, the next highest priority session in window 304B, etc. until a user selectable number of displayable conversation has been filled. In some embodiments, the IM client 170 may automatically respond to low priority conversations to inform the user/sender that the primary user is busy and that it may be some time before they receive a reply.

In some embodiments, primary IM user may “lock” the highest priority pane 310A until that user chooses another session to replace the conversation in that pane (e.g., by selecting “B” icon 310b or closing pane 310a); and the priority and ordering of conversations B-G is dynamic. In other embodiments, all of the panes 310 may be dynamically selected. Regardless, all chat sessions in these embodiments share a single window 302 and a single text entry pane, with the text being sent to the currently selected icon.

Some IM system 100 embodiments may further weight the priority assigned to particular users using social networking techniques. Still other embodiments may use directory information, such as title, management status, and department organization, to provide starting values and/or to weight that user's priority score. Thus, in one embodiment, the system 100 assigns a medium priority to people within a user's own department, a high priority to the user's first and second line managers or team leads, and low priority to all other users.

Some embodiments may further consider the user's interaction with the operating system, IM application, word processor application, or other desktop resources to compute the dynamic component. For example, if a sender sends a message containing “thanks” and then closes their IM session, the recipient's IM session could display the “thanks” and fade away/close unless the window/icon is touched. Similarly, the one user is typing text in their text input area 308, the excess noise filter will suppress all text until the thought completes. This could range from monitoring the typing (if X seconds pass, display the message), to analyzing the content and if it is personal or non-work related, then it can be very low priority or not displayed at all.

Still other embodiments may use textual analysis to allow for additional intelligence in determining the relative importance of a message. In these embodiments, a message like “see ya later” would not significantly bump up the score of a conversation; whereas a reference related to an open application, or its content, within the client device 102 would bump the conversation significantly. Thus, for example, when a programmer/user is developing an application in an IDE for a particular project, other messages about that particular IDE or that particular project would have high priority. Those skilled in the art will appreciate that these same techniques can be used to analyze the sender's system to determine whether or not the sender is asking an important question.

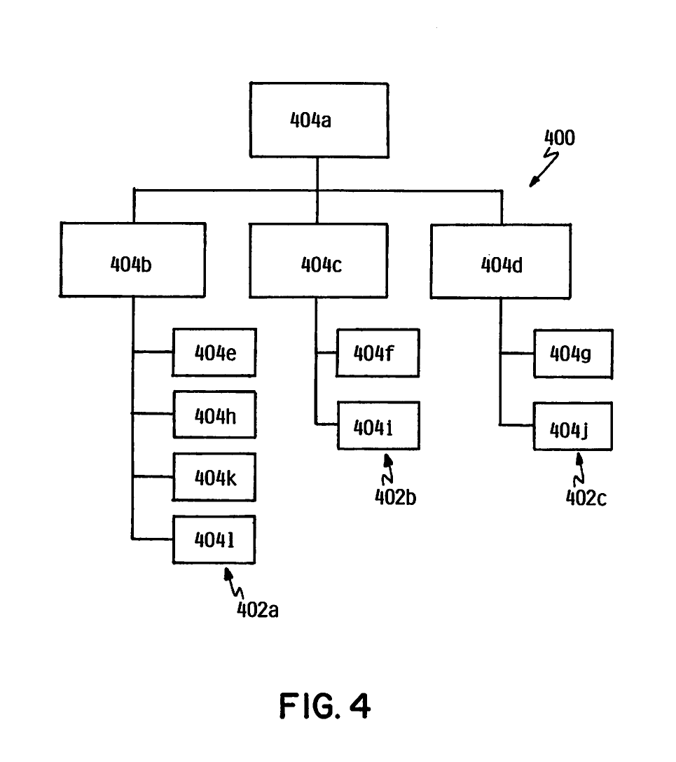

FIG. 4 illustrates one data structure 400 embodiment used to classify individuals for the base score. The structure 400 in this embodiment comprises a tree list of users of which UI client 102 is aware. The different branches 402 of the tree represent something the users of those devices 102 have in common, such as being on the same project team. Depending on the responsibilities of the user of the chat client 102, some people 404 within each team 402 may have a higher base importance or base priority than others. Thus, in this example, the user of chat client 404a might be a manager in charge of a complex project, the users of chat clients 404b-404d may be team leads 404b-404d reporting to the manager 404, and the users of chat clients 404e-404n are workers directly reporting to team leads 404b-404d.

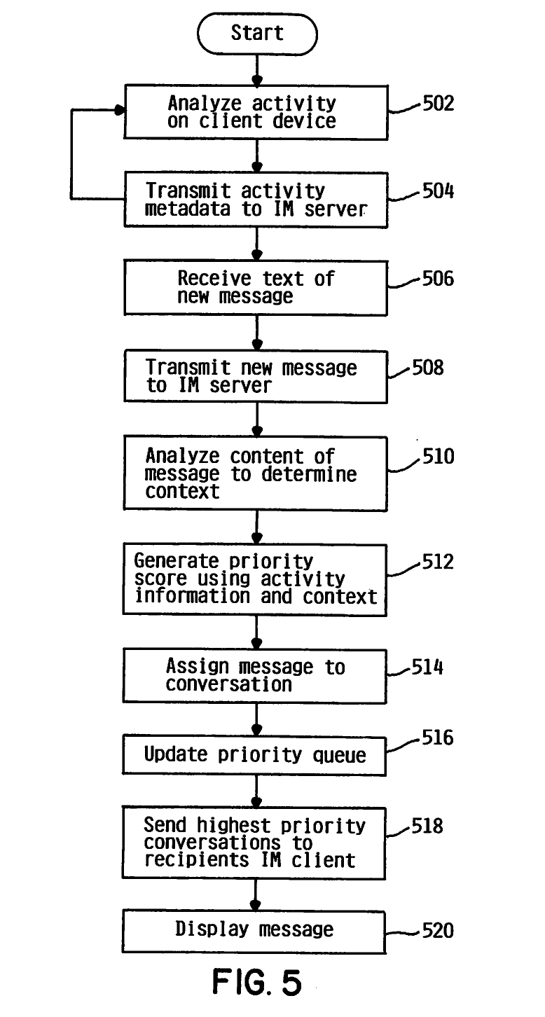

FIG. 5 illustrates one method 500 of managing a priority queue. At block 502, the sender's IM client 170 analyzes the activity on the sender's IM client 102. At block 504, the IM client 170 sends this information as a message to the IM server 104. At block 506, the recipient's IM client 170 similarly analyses the activity level on its device 102 and sends this information to the IM server 104 at block 507. Blocks 502-507 repeat periodically in this embodiment.

At block 508, the sender/user composes a message to be sent to the recipient/user. At block 510, the server computer 104 analyzes the text of the sent message, the sender's activity, and the recipient's activity to determine a priority adjustment score for the message. At block 510, the server computer 104 sends the message to the recipient's IM client device 102 along with the priority adjustment score. At block 512, the recipient's client device 102 assigns the message to the appropriate conversation 304 or 310 and then uses the priority adjustment to place the conversation in the ranked priority queue. At block 514, a callback mechanism allows the queue manager 152 to determine which conversations have the highest priority and, based on each user's profile, whether the conversation should be presented the user/recipient. This callback mechanism will constantly reevaluate the user/recipient's activity to determine whether the user/recipient's activity has dropped sufficiently to warrant presentation of lower priority conversations.

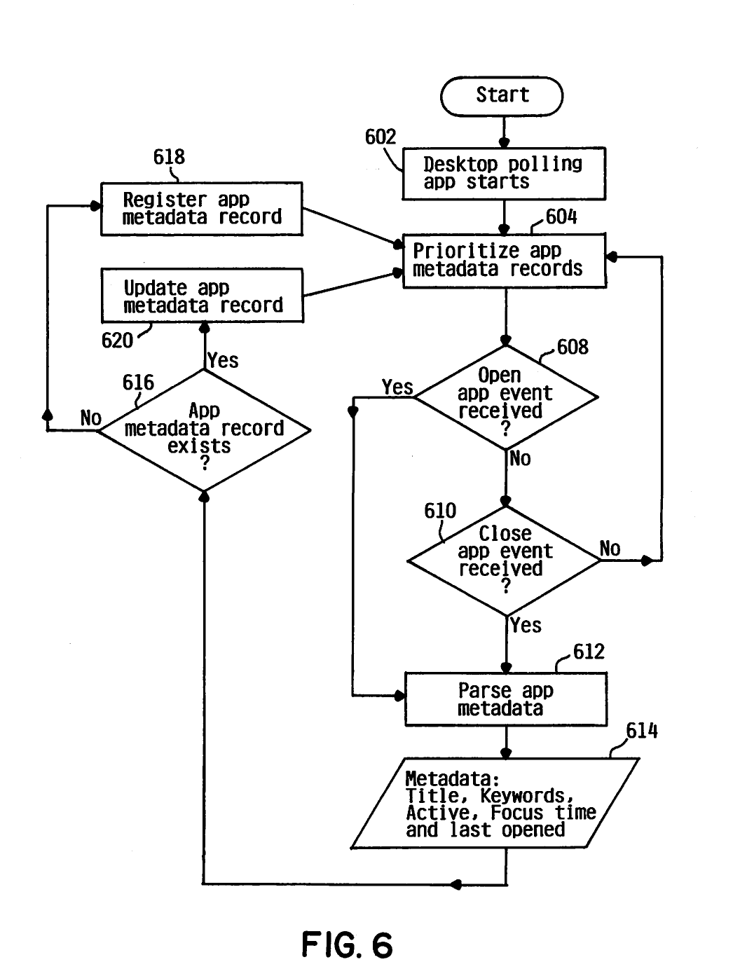

FIG. 6 illustrates one method of determining an activity level for the dynamic component. At block 602, the IM client 170 begins polling applications to generate a list of what applications are active in memory, what keywords are associated with that application (and document, if applicable), how long the application has been in focus, and when the application was last opened/in focus. At block 604, the message queuing system uses this information to generate an initial list of conversations. At blocks 608-610, if the IM client 170 determines that an application has been opened or closed, the IM client 170 will then parse the application metadata to determine what the primary user is doing at block 612. Suitable metadata includes title of the application, title of the window, focus time, and last opened time. The IM client will then transmit the updated information to the queue manager at block 614. Next, at block 616, the queue manager will determine whether the application metadata already exists for this application. If so, the queue manager will update the metadata record at block 620. If not, the queue manager will register the new application at block 618.

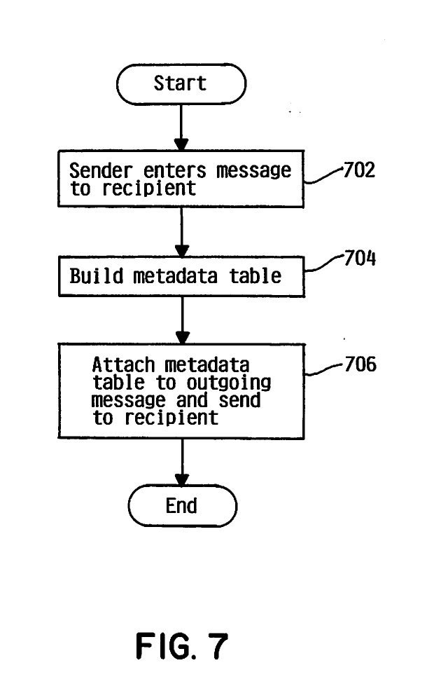

FIG. 7 illustrates the operation of the sending IM client 170. At block 702, the sender selects a recipient and enters a message. The IM client 170 then automatically builds the metadata table described with reference to FIG. 2A at block 704, then attaches the environment metadata to the outgoing message and transmits the enhanced message to the IM server 104 at block 706.

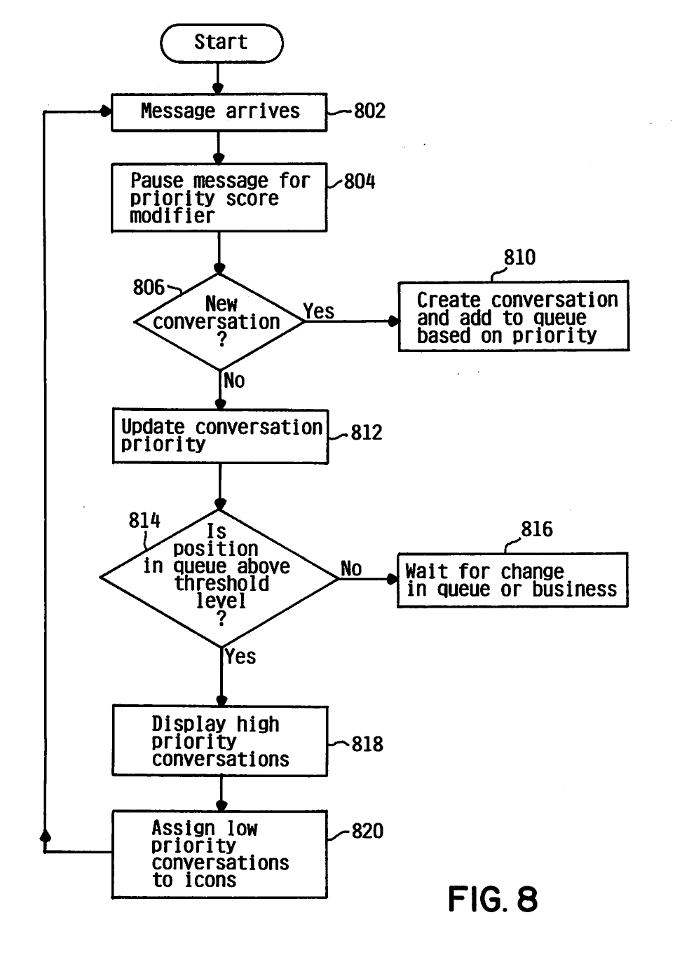

FIG. 8 illustrates the operation of the receiving IM client 102. At block 802, the IM client 102 receives a message. At block 804, the IM client 102 parses the received message for an initial priority score or a priority score update. If this is a new conversation, the IM client 170 creates a new conversation for the sender at block 810 and places the conversation into the priority queue at the appropriate place using the sender's default priority value and the received priority modifier. If this message is for an existing conversation, the IM client 170 uses the priority modifier to update the conversation's place in the priority queue at block 812.

At block 814, for each conversation, the IM client 102 determines if its priority score is above a threshold level. If no suitably high priority conversations exist, the IM client 170 waits at block 816 for a change in the priority queue or a change in the threshold. At block 818, the IM client 170 begins displaying the conversations to the primary user, in order of the conversation's priority score, until a user-selected maximum number of simultaneous conversations have been met. At block 820, the IM client 170 assigns the conversations that do not meet the display threshold or that are below higher ranked conversations to un-displayed conversation icons 310. In some embodiments, the sender is also notified that the message has been received and is in a queued state.

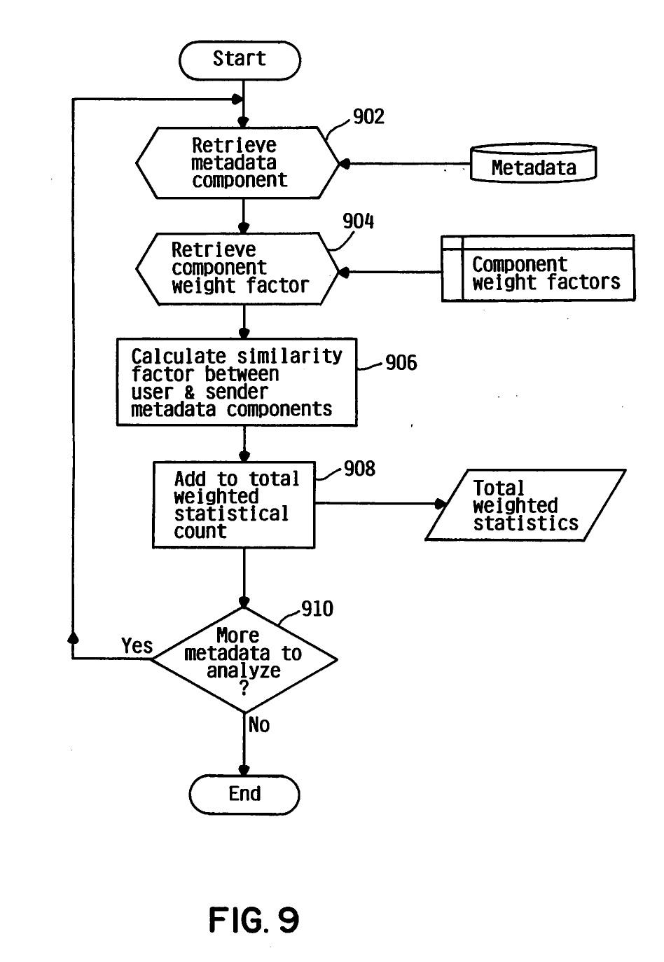

FIG. 9 illustrates one method of using metadata to calculate the dynamic component. At block 902, the message queuing system 152 retrieves the metadata components 206-212 from the database 200. At block 904, the message queuing system 152 retrieves a component weight factor (i.e., a default priority for each item of metadata 203) from a user template 129. At block 906, the message queuing system 152 calculates a similarity factor between the user/recipient and the user/sender metadata components. At block 908, the message queuing system 152 adds to the total weighted statistical count. At block 910, the message queuing system 152 determines if it needs to analyze more data. If so, it returns to block 902, otherwise it exits.

One suitable way to generate keyword metadata 206 is to use the display contents represented within a program using accessibility APIs, similar to those utilized by screen readers, to intercept what words are being shown for any application active on the IM client 102. Once this display content is known, some embodiments use UIMA (Unstructured Information Management Architecture) to interpret the full meaning of sentences. This technology uses annotators in a pipeline framework to understand data with a high degree of confidence. The top stages are name disambiguators and domain specific context mappings. The IM client 102 can make these understandings with a degree of confidence (do we know what it says) and certainty (does the text of the document leave ambiguity in the language). Thus, for example, the IM client 170 can analyze a document and determine that it has a DIAGNOSIS of Leukemia for patient JOHN DOE, because the person had NOT headaches AND poor muscle tone. In the case where applications are written to aid in the implementation of our invention (or plug-ins for current applications are created), then callback methods could be provided to allow the IM client to probe application content. More information about UIMA techniques can be found in:
D. Ferrucci and A. Lally. “UIMA: an architectural approach to unstructured information processing in the corporate research environment,” Natural Language Engineering 10, No. 3-4, 327-348 (2004).
D. Ferrucci and A. Lally, “Building an example application with the Unstructured Information Management Architecture,” IBM Systems Journal 43, No. 3, 455-475 (2004).
T. Goetz and O. Suhre “Design and implementation of the UIMA Common Analysis System,” IBM Systems Journal 43, No. 3, 490-515 (2004).
Anthony Levas, Eric Brown, J. William Murdock, and David Ferrucci. “The Semantic Analysis Workbench (SAW): Towards a Framework for Knowledge Gathering and Synthesis.” Proceedings of the International Conference on Intelligence Analysis. McClean, Va., May 2-6, 2005.
   which are herein incorporated by reference in their entirety. Those skilled in the art will appreciate that the other metadata components 208-212 can be generated using standard calls to the operating system.

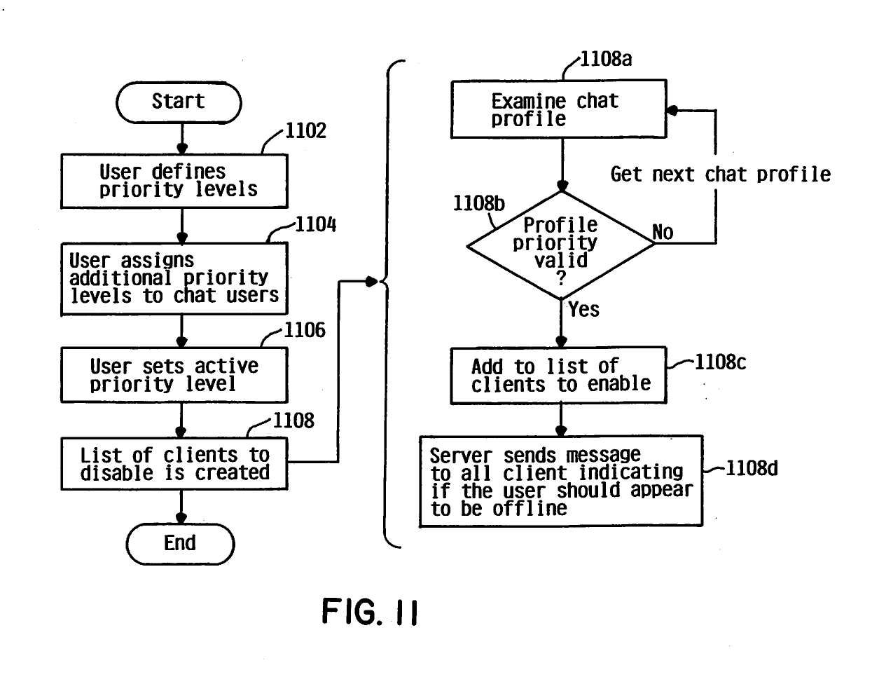

FIG. 11 illustrates a method of managing online presence. At block 1102-1104, the primary user (and/or system administrator) defines one or more priority levels and assigns those levels to the other individuals and groups in the system 100. At block 1106, the primary user sets an initial active priority level, which is then transmitted to the queue manager. The queue manager, in turn, uses this information at block 1108 to generate an initial list of clients to which it will broadcast the primary user's online presence. In this embodiment, this comprises examining the profiles of each other user in the system 100 (block 1108a), determining whether that profile exceeds the current busy-ness level (block 1108b), adding that user to the list of clients to enable (block 1108c), and then sending a message to all of the clients indicating that the user is online (block 1108d)

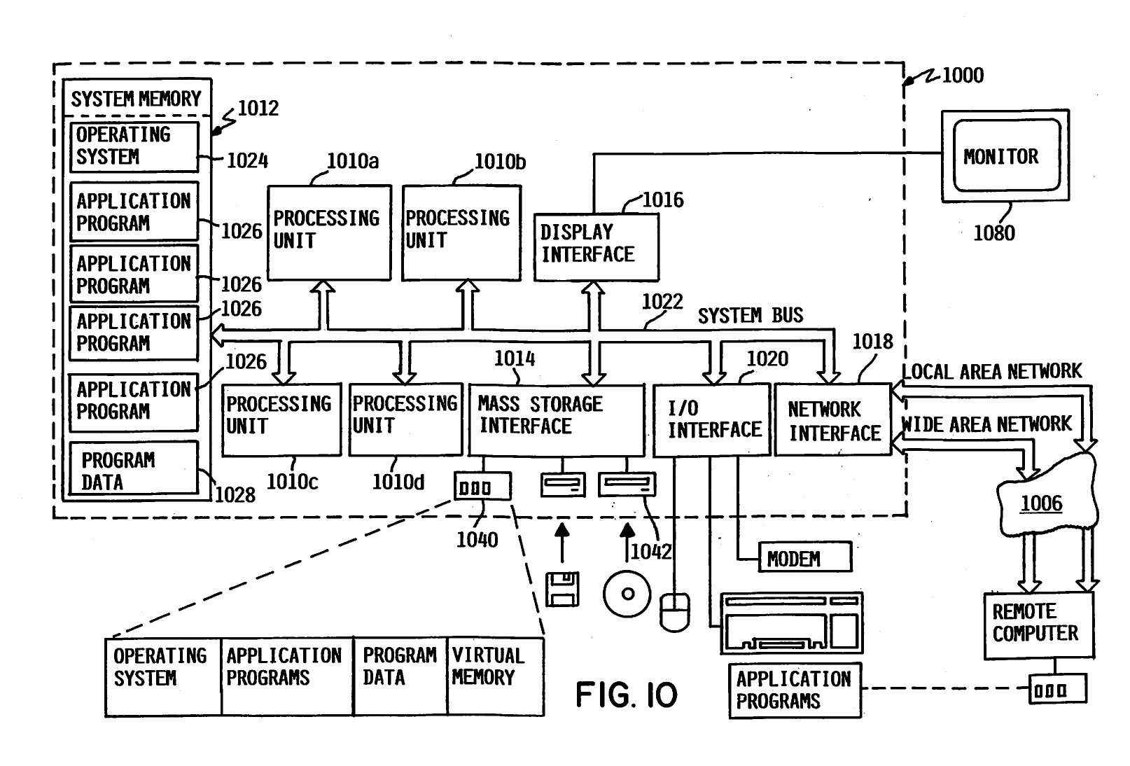

FIG. 10 illustrates a computer system 1000 suitable for use as a client device 102 or an IM server system 104. It should be understood that this figure is only intended to depict the representative major components of the computer system 1000 and that individual components may have greater complexity that represented in FIG. 10. Moreover, components other than or in addition to those shown in FIG. 10 may be present, and that the number, type, and configuration of such components may vary. Several particular examples of such additional complexity or additional variations are disclosed herein; it being understood that these are by way of example only and are not necessarily the only such variations.

This computing system 1000 embodiment comprises a plurality of central processing units 1010a-1010d (herein generically referred to as a processor 1010 or a CPU 1010) connected to a main memory unit 1012, a mass storage interface 1014, a terminal/display interface 1016, a network interface 1018, and an input/output (“I/O”) interface 1020 by a system bus 1022. The mass storage interfaces 1014, in turn, connect the system bus 1022 to one or more mass storage devices, such as a direct access storage device 1040 or a readable/writable optical disk drive 1042. The network interfaces 1018 allow the computer system 1000 to communicate with other computing systems 1000 over the communications medium 1006. The main memory unit 1012 in this embodiment also comprises an operating system 1024, a plurality of application programs 1026 and some program data 1028.

The computing system 1000 in this embodiment is a general-purpose computing device. Accordingly, the CPU's 1010 may be any device capable of executing program instructions stored in the main memory 1012 and may themselves be constructed from one or more microprocessors and/or integrated circuits. In this embodiment, the computing system 1000 contains multiple processors and/or processing cores, as is typical of larger, more capable computer systems; however, in other embodiments, the computing systems 1000 may comprise a single processor system and/or a single processor designed to emulate a multiprocessor system.

When the computing system 1000 starts up, the associated processor(s) 1010 initially execute the program instructions that make up the operating system 1024, which manages the physical and logical resources of the computer system 1000. These resources include the main memory 1012, the mass storage interface 1014, the terminal/display interface 1016, the network interface 1018, and the system bus 1022. As with the processor(s) 1010, some computer system 1000 embodiments may utilize multiple system interfaces 1014, 1016, 1018, 1020, and busses 1022, which in turn, may each include their own separate, fully programmed microprocessors.

The system bus 1022 may be any device that facilitates communication between and among the processors 1010; the main memory 1012; and the interfaces 1014, 1016, 1018, 1020. Those skilled in the art will appreciate that the system bus 1022 may be a relatively simple, single bus structure that provides a direct communication path among the system bus 1022 (as depicted in FIG. 10), or may be a more complex structure, such as point-to-point links in hierarchical, star or web configurations; multiple hierarchical buses; parallel and redundant paths, etc.

The main memory 1012 and the mass storage devices 1040 work cooperatively in this to store the operating system 1024, the application programs 1026, and the program data 1028. In this embodiment, the main memory 1012 is a random-access semiconductor device capable of storing data and programs. Although FIG. 10 conceptually depicts this device as a single monolithic entity, the main memory 1012 in some embodiments may be a more complex arrangement, such as a hierarchy of caches and other memory devices. For example, the main memory 1012 may exist in multiple levels of caches, and these caches may be further divided by function, so that one cache holds instructions while another holds non-instruction data, which is used by the processor or processors. Memory may be further distributed and associated with different CPUs 1010 or sets of CPUs 1010, as is known in any of various so-called non-uniform memory access (NUMA) computer architectures. Moreover, some embodiments may utilize virtual addressing mechanisms that allow the computing systems 1000 to behave as if it has access to a large, single storage entity instead of access to multiple, smaller storage entities such as the main memory 1012 and the mass storage device 1040.

Although the operating system 1024, the application programs 1026, and the program data 1028 are illustrated as being contained within the main memory 1012, some or all of them may be physically located on different computer systems and may be accessed remotely, e.g., via the communications medium 106, in some embodiments. Thus, while the operating system 1024, the application programs 1026, and the program data 1028 are illustrated as being contained within the main memory 1012, these elements are not necessarily all completely contained in the same physical device at the same time, and may even reside in the virtual memory of other computer systems 1000.

The system interface units 1014, 1016, 1018, 1020 support communication with a variety of storage and I/O devices. The mass storage interface unit 1014 supports the attachment of one or more mass storage devices 1040, which are typically rotating magnetic disk drive storage devices, although they could alternatively be other devices, including arrays of disk drives configured to appear as a single large storage device to a host and/or archival storage media, such as hard disk drives, tape (e.g., mini-DV), writeable compact disks (e.g., CD-R and CD-RW), digital versatile disks (e.g., DVD, DVD-R, DVD+R, DVD+RW, DVD-RAM), holography storage systems, blue laser disks, IBM Millipede devices and the like.

The terminal/display interface 1016 directly connects one or more display units 1080 to the computer system 1000. These display units 1080 may be non-intelligent (i.e., dumb) terminals, such as a cathode ray tube, or may themselves be fully programmable workstations used to allow IT administrators and users to communicate with the computing system 1000. Note, however, that while the interface 1016 is provided to support communication with one or more displays 1080, the computer systems 1000 does not necessarily require a display 1080 because all needed interaction with users and other processes may occur via network interface 1018.

The computing system 1000 in FIG. 10 is depicted with multiple attached terminals 1080, such as might be typical of a multi-user “mainframe” computer system. In such a case, the actual number of attached devices is typically greater than those shown in FIG. 10, although the present invention is not limited to systems of any particular size. The computing systems 1000 may alternatively be a single-user system, typically containing only a single user display and keyboard input, or might be a server or similar device which has little or no direct user interface, but receives requests from other computer systems (clients). In other embodiments, the computing systems 1000 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The communications medium 106 may be any suitable network or combination of networks and may support any appropriate protocol suitable for communication of data and/or code to/from multiple computing systems 1000. Accordingly, the network interfaces 1018 can be any device that facilitates such communication, regardless of whether the network connection is made using present day analog and/or digital techniques or via some networking mechanism of the future. Those skilled in the art will appreciate that many different network and transport protocols can be used to implement the network. The Transmission Control Protocol/Internet Protocol (“TCP/IP”) suite contains suitable network and transport protocols.

One exemplary computing system 1000, particularly suitable for use as a client device 102 and/or a server computer 104 is the System i platform running the i5/OS multitasking operating system, both of which are available from International Business Machines Corporation of Armonk, N.Y. However, those skilled in the art will appreciate that the methods, systems, and apparatuses of the present invention apply equally to any computing system 1000 and operating system combination, regardless of whether one or both of the computer systems 1000 are complicated multi user computing apparatuses, a single workstations, lap-top computers, mobile telephones, personal digital assistants (“PDAs”), video game systems, or the like.

Although the present invention has been described in detail with reference to certain examples thereof, it may be also embodied in other specific forms without departing from the essential spirit or attributes thereof. For example, those skilled in the art will appreciate that the present invention is capable of being distributed as a program product in a variety of forms, and applies equally regardless of the particular type of tangible, computer-readable signal bearing medium used to actually carry out the distribution. Examples of suitable tangible, computer-readable signal bearing media include, but are not limited to: (i) non-writable storage media (e.g., read only memory devices (“ROM”), CD-ROM disks readable by a CD drive, and Digital Versatile Disks (“DVDs”) readable by a DVD drive); (ii) writable storage media (e.g., floppy disks readable by a diskette drive, CD-R and CD-RW disks readable by a CD drive, random access memory (“RAM”), and hard disk drives); and (iii) communications media (e.g., computer networks, such as those implemented using “Infiniband” or IEEE 802.3× “Ethernet” specifications; telephone networks, including cellular transmission networks; and wireless networks, such as those implemented using the IEEE 802.11×, IEEE 802.16, General Packet Radio Service (“GPRS”), Family Radio Service (“FRS”), and Bluetooth specifications). Those skilled in the art will appreciate that these embodiments specifically include computer software downloaded over the Internet.

The present invention may also be embodied part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. These service engagement embodiments may be directed at providing both end-to-end IM services, to providing only the back-end IM services, or some combination thereof. Accordingly, these embodiments may further comprise receiving charges from other entities and associating that charge with users of the IM system 100.

In addition, although the embodiments described with reference to FIGS. 1-11 generally utilize a client-server network architecture, other network designs and configurations are possible. For example, some embodiments may use a decentralized (i.e., non-authorative) client-server architecture, similar to the Jabber architecture described in RFC 3920. Still other embodiments may use peer-to-peer architectures and three-tier architectures. Accordingly, the terms IM server 104 and IM client 102 should not be construed as limiting the invention to client-server network architectures. Moreover, in some embodiments, many of the functions described above as performed on the server computer 104 may be performed on one or more of the client devices 102, and vice-versa. Thus, for example, the priority queue and queue manager 152 in some embodiments may be associated with the client device 102. These embodiments may be desirable to assuage privacy concerns and/or for use in heterogeneous networks. Similarly, in some embodiments, the priority queue manager 152 may be associated with a different physical server 104 than the database.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention. Therefore, it is desired that the embodiments described herein be considered in all respects as illustrative, not restrictive, and that reference be made to the appended claims for determining the scope of the invention.

1. A method for selectively filtering instant messages, comprising:
receiving an instant message; and
analyzing the instant message to generate a priority score.

2. The method of claim 1, wherein the analyzing comprises generating a default priority score for the instant message.

3. The method of claim 2, wherein the default priority score is based at least in part on the identity of a sender of the instant message.

4. The method of claim 2, wherein the default priority score is based at least in part on a group associated with a sender of the instant message; and

5. The method of claim 1, wherein the analyzing comprises dynamically updating the priority score.

6. The method of claim 5, further comprising selectively displaying the instant message based at least in part on the updated priority score.

7. The method of claim 6, wherein selectively displaying the instant message comprises:
providing a graphical user interface comprising at least one visible conversation pane and at least one minimized conversation pane;
displaying a relatively higher priority conversation in the at least one visible conversation pane; and
assigning relatively lower priority conversations to the at least one minimized conversation panel.

8. The method of claim 7, wherein dynamically updating the priority score comprises:
detecting user activity on a client device; and
changing the priority score based on the analysis.

9. The method of claim 8, wherein the detected user activity comprises detecting an activity chosen from the group consisting of:
user activity in an instant messaging application; and
user activity in non-instant messaging application.

10. The method of claim 7, further comprising analyzing the content of user interaction with the client device.

11. The method of claim 7, further comprising determining an on-line presence level based at least in part on the analysis of the other users.

12. The method of claim 7, wherein dynamically updating the priority score comprises:
analyzing the activity of other users in an instant messaging system; and
changing the priority score based on the analysis.

13. The method of claim 12, wherein the analysis of the activity of other users comprises an activity chosen from the group consisting of:
other user activity in an instant messaging application; and
other user activity in non-instant messaging application.

14. The method of claim 7, wherein the analysis comprises:
analyzing a conversation history associated with an instant message partner.

15. A method for deploying computing infrastructure, comprising integrating computer readable code into a computing system, wherein the code in combination with the computing system is adapted to perform the method of claim 1.

16. A graphical user interface for an instant messaging application, comprising:
at least one visible conversation pane for displaying relatively higher priority conversations; and
at least one minimized conversation pane representing relatively lower priority conversations to the at least one minimized conversation panel.

17. The graphical user interface of claim 16, further comprising a busy-ness level selector for indicating a priority score required to have a message displayed in the at least one visible conversation pane.

18. A method for deploying computing infrastructure, comprising integrating computer readable code into a computing system, wherein the code in combination with the computing system is adapted to perform the method of claim 15.

19. A computer program product, comprising:
a) a program configured to perform a method for selectively filtering instant messages, comprising:
receiving an instant message; and
analyzing the instant message to generate a priority score.
b) a computer readable media bearing the program.

20. The computer program product of claim 19, wherein the program further comprises a graphical user interface for an instant messaging application, comprising:
at least one visible conversation pane for displaying relatively higher priority conversations; and
at least one minimized conversation pane representing relatively lower priority conversations to the at least one minimized conversation panel.
